(19) United States
(12) Patent Application Publication
(10) Pub. No.: US 2012/0308794 A1
(43) Pub. Date: Dec. 6, 2012

(54) OPTICAL COMPOSITE SUBSTRATE

(76) Inventors: Cheng-Chuan Lai, Hsin-Chu (TW); Jen-Yuan Chi, Hsin-Chu (TW)

(21) Appl. No.: 13/239,393

(22) Filed: Sep. 22, 2011

(30) Foreign Application Priority Data
Jun. 1, 2011 (TW) 100119191

(51) Int. Cl. B32B 7/02

(52) U.S. Cl. 428/213; 428/212

(57) ABSTRACT

An optical composite substrate is disclosed and includes a substrate, a first coating layer, and a second coating layer. The substrate has a first surface and a second surface opposite to the first surface. The first coating layer is formed on the first surface; the second coating layer is formed on the second surface. Therein, the stiffness of the first coating layer is substantially equal to the stiffness of the second coating layer. When a thermal deformation of the optical composite substrate is induced by a change in temperature, the whole deformation of the optical composite substrate is reduced by the constraint effect on the substrate by the first coating layer and the second coating layer. Therefore, the optical composite substrate can keep its flatness within a certain range, so as to solve the problem in the prior art that an optical film sheet easily warps when heated.

### BACKGROUND OF THE INVENTION

1. Field of the Invention

The invention relates to an optical composite substrate, and especially relates to an optical composite substrate with a strengthening coating layer on each side thereof.

2. Description of the Prior Art

Conventional optical films are commonly used in LCD monitors. The backlight illuminates the optical film in a long time so that the optical film absorbs heat to expand. However, not everywhere absorbs heat in the same amount; further, the heat-dissipation capability everywhere is not the same, either. Hence, the heat expansion everywhere of the optical film is seldom the same, leading to warping. For the LCD monitors, the warping induces p-mura or a ripple phenomenon, which seriously affects the displaying quality of the LCD monitors.

In view of this problem, a common solution is to dissipate heat by a heat-dissipating module in order to decrease the temperature of the optical film and then to reduce the degree of the warping. In a current heat-dissipation mechanism, the heat-dissipating module may decrease the temperature of the optical film, but the temperature distribution of the optical film is still non-uniform. Although the increase in temperature is not the only one cause of warp the optical film, the non-uniform temperature distribution makes the warping of the optical film worse. Therefore, there is another solution of increasing the thickness of the substrate of the optical film to improve the anti-warp capability thereof. The way to increase the thickness of the substrate is usually to use a thicker substrate or to stick two thinner substrates together to form a thicker composite substrate.

However, the material of a common substrate is soft. Such single common substrate needs to increase its thickness to a certain value for a significant anti-warp effect. So under a design restriction on the thickness of the optical film, the anti-warp improvement is limited just by using the optical film having a thicker substrate. The way of sticking two thinner substrates together attempts to produce symmetrical stresses constraining each other so as to anti-warp. It is based on a premise that a trend of deforming symmetrically exists. However, the material of the common optical film has an orientation. An adherence with alignment is difficult to be made, leading to the difficulty in overcoming the orientation problem. The anti-warp improvement is limited as well. In addition, not only does the thicker optical film increase the thickness of the whole optical module, but also the dimensions of any part engaged with the optical module need to be changed, which makes the design and manufacturing thereof troublesome.

### SUMMARY OF THE INVENTION

An objective of the invention is to provide an optical composite substrate, on each side of which there is a strengthening coating layer. The deformation of the substrate is constrained by use of the feature of the same stiffness of the two strengthening coating layers, so as to reduce the warp of the whole optical composite substrate. It solves the problem that the optical film in the prior art easily warps due to the temperature rise or the non-uniform temperature distribution.

The optical composite substrate of the invention includes a substrate, a first coating layer, and a second coating layer. The substrate has a first surface and a second surface opposite to the first surface. The first coating layer is formed on the first surface. The second coating layer is formed on the second surface. Therein, the stiffness of the second coating layer is equal to the stiffness of the first coating layer. Therefore, the optical composite substrate uses the two coating layers with same stiffness formed on the two sides of the substrate so that the substrate thereon has a substantially symmetrical stress distribution induced when the temperature thereof increases or when the temperature distribution is non-uniform, which reduces the degree of the warping of the substrate. Further, if the first coating layer and the second coating layer are structurally symmetrical to be formed on the substrate, the warping of the substrate can be almost reduced so that the planarity of the optical composite substrate can be maintained.

In sum, the optical composite substrate of the invention uses the two coating layers with same stiffness formed on the two sides of the substrate so as to induce a symmetrical stress on the substrate, which efficiently reduces the degree of the warping of the whole optical composite substrate. Therefore, the optical composite substrate of the invention can efficiently reduce the deformation thereof without consideration to the orientation of the substrate when the temperature increases or the temperature distribution is non-uniform; it solves the warping problem of the optical film in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a sectional view of an optical composite substrate of a preferred embodiment according to the present invention.

FIG. 2 is a schematic diagram illustrating a sectional view of an optical film of a preferred embodiment according to the present invention.

FIG. 3 is a schematic diagram illustrating the lamination interface induced in an optical film made by a lamination process in the prior art.

### DETAILED DESCRIPTION

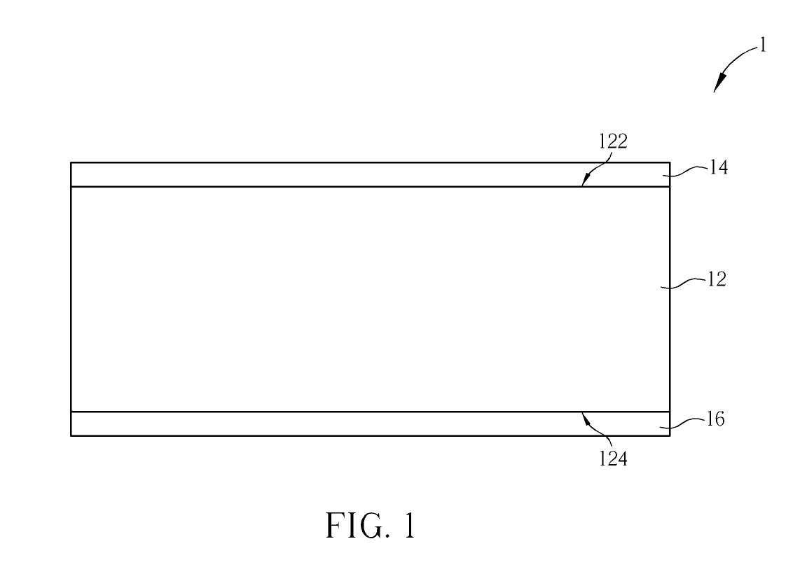

Please refer to FIG. 1. FIG. 1 is a schematic diagram illustrating a sectional view of an optical composite substrate 1 of a preferred embodiment according to the present invention. The optical composite substrate 1 includes a substrate 12, a first coating layer 14, and a second coating layer 16. The substrate 12 has a first surface 122 and a second surface 124 opposite to the first surface 122. The first coating layer 14 is formed on the first surface 122. The second coating layer 16 is formed on the second surface 124. The stiffness of the second coating layer 16 is equal to the stiffness of the first coating layer 14. Therein, for simple illustration, the ratio of the thickness of each of the first coating layer 14 and the second coating layer 16 to the thickness of the substrate 12 is exaggeratedly shown in FIG. 1.

In the embodiment, the substrate 12 is mainly made of Polyethylene Terephthalate (PET) or other common high molecular polymer. The first coating layer 14 and the second coating layer 16 are mainly made of UV hardened resin, epoxy resin, or other resin and are formed directly on the substrate 12 in a stressless way, for example, by a conventional roller coating or other coating methods. In the embodiment, the thickness of each of the first coating layer 14 and the second coating layer 16 is substantially 2.0%˜12.0% of a thickness of the substrate 12. For example, if the thickness of the substrate 12 is 250 μm, the thickness of each of the first coating layer 14 and the second coating layer 16 is 5 μm˜30 μm; however, the invention is not limited to it. In practice, the thickness may depend on an actual test or a product specification. After the first coating layer 14 and the second coating layer 16 are coated, a hardening process on the UV hardened resin with UV or on the epoxy resin with a hardener is performed. After hardened, the stiffness of each of the first coating layer 14 and the second coating layer 16 is higher than the stiffness of the substrate 12. Under the same stress, the induced deformation of each of the first coating layer 14 and the second coating layer 16 is less than that of the substrate 12. Therefore, the first coating layer 14 and the second coating layer 16 can reduce the deformation of the substrate 12.

Because the stiffness of each of the first coating layer 14 and the second coating layer 16 is higher than the stiffness of the substrate 12, the thickness of each of the first coating layer 14 and the second coating layer 16 can be much less than the thickness of the substrate 12 to provide an efficient structure constraint. That is, when the temperature of the optical composite substrate 1 changes or the temperature distribution is non-uniform, the first coating layer 14 and the second coating layer 16 can provide constrain stress on the two sides of the substrate 12, so as to reduce the degree of the warping of the substrate 12. The degree of the warp deformation of the whole optical composite substrate 1 is therefore reduced. In the embodiment, the first coating layer 14 and the second coating layer 16 are made of the same material and are formed on the substrate 12 to be structurally symmetrical, so the warping of the substrate 12 can almost be reduced in principle so that the planarity of the optical composite substrate 1 can be maintained; however, the invention is not limited to it. In principle, there are the two coating layers 14 and 16 with the same stiffness on the two sides of the substrate 12, which produces a significant anti-warp effect. It is added that, in practice, the materials of the substrate 12, the first coating layer 14, and the second coating layer 16 are not limited to the above. The choice for the materials affects the thickness ratio between the substrate 12, the first coating layer 14, and the second coating layer 16. In principle, if the stiffness of each of the first coating layer 14 and the second coating layer 16 is higher than the stiffness of the substrate 12, the anti-warp effect on the whole optical composite substrate 1 is better; however, in practice, the invention is not limited to it.

It is added more that, in the above embodiment, the first coating layer 14 and the second coating layer 16 are formed directly on the substrate 12 without any intermedium therebetween, but the invention is not limited to it. For example, another coating layer can be formed between the substrate 12 and the first coating layer 14 or between the substrate 12 and the second coating layer 16. The coating layer can be an adhesion layer for improving the whole structural strength or can satisfy optical requirements such as filtering. Alternatively, the first coating layer 14 and the second coating layer 16 respectively react with the substrate 12 to form a reaction layer which usually can improve the adhesion strength between the substrate 12 and the first coating layer 14 or the second coating layer 16, so as to enhance the deformation constraint effect of the first coating layer 14 or the second coating layer 16 on the substrate 12; that is, the first coating layer 14 and the second coating layer 16 can provide stable shear stress on the substrate 12 when the substrate 12 tends to deform. Furthermore, in the above embodiment, the substrate 12 is made of homogeneous material; however, the invention is not limited to it. Depending on different applications, the optical composite substrate 1 can be made of uniformly mixed material in practice; for example, the substrate 12 contains reflective particles so as to perform diffusion. In addition, the optical composite substrate 1 of invention can be the substrate of a conventional optical film. In practice, there may be other optical layers such as diffusion layers and prism layers on the optical composite substrate 1. In this case, the substrate 12, the first coating layer 14, and the second coating layer 16 are designed to be light-penetrable.

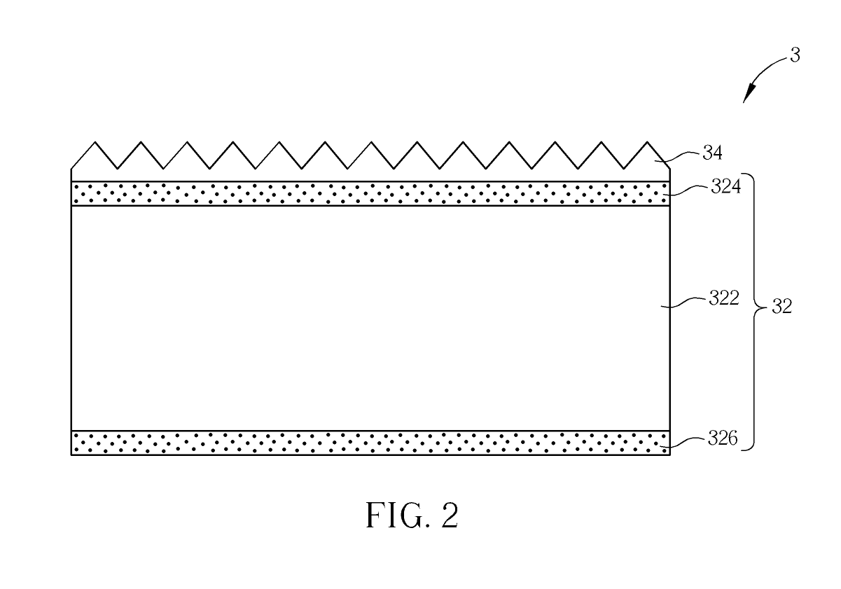

Please refer to FIG. 2. FIG. 2 is a schematic diagram illustrating a sectional view of an optical film 3 of a preferred embodiment according to the present invention. The optical film 3 includes an optical composite substrate 32 and a prism layer 34 formed on the optical composite substrate 32. Therein, for simple illustration, the thickness ratio of each layer of the optical composite substrate 32 is exaggeratedly shown in FIG. 2. The optical composite substrate 32 and the optical composite substrate 1 are substantially identical in structure. The main difference is that the first coating layer 324 and the second coating layer 326 formed on the two sides of the substrate 322 may include a plurality of organic or inorganic particles, reflective material, a plurality of metal particles, or glass fiber for improving the stiffness of each of the first coating layer 324 and the second coating layer 326, which is conducive to reduction in the thicknesses of the first coating layer 324 and the second coating layer 326 relative to the first coating layer 14 and the second coating layer 16. Therein, the reflective material can also be regarded as media for reflecting light so that the first coating layer 324 and the second coating layer 326 can perform light diffusion as well.

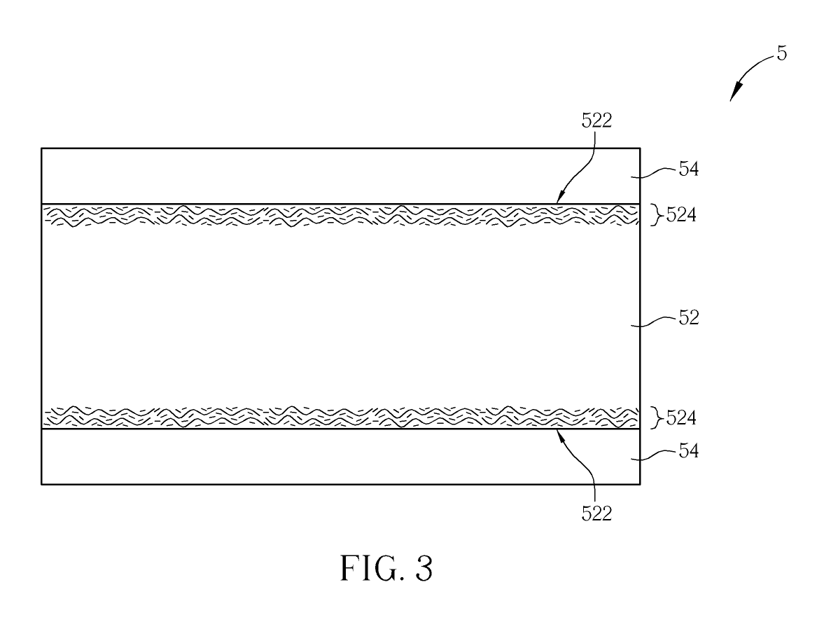

Please refer to FIG. 3. FIG. 3 is a schematic diagram illustrating the lamination interface induced in an optical film 5 made by a lamination process in the prior art. In the lamination process, light-penetrable layers 54 is not coated on a substrate 52 in advance but formed in advance then to be jointed with the substrate 52. So, the light-penetrable layers 54 needs being heated and pressed so as to be jointed onto the substrate 52. As shown in FIG. 3, after the light-penetrable layers 54 and the substrate 52 of the optical film 5 are heated and pressed to be jointed with each other, there is a deformed area 524 induced in the substrate 52 adjacent to a junction interface 522 of the substrate 52 and the light-penetrable layers 54. The deformed area 524 is the area where the crystalline texture of the substrate 52 is deformed by the lamination process. The crystalline texture in the deformed area 524 is easily crushed. The penetrability of the substrate 52 is reduced so that the higher energy the substrate 52 absorbs, the higher the temperature of the substrate 52 increases, which is harmful to reducing warping.

On the contrary, in the above embodiment according to the invention, the coating layers 14, 16, 34 and 36 of the optical composite substrates 1 and 3 are formed on the substrates 12 and 32 in a stressless way. There is no obvious deformation of the crystalline texture induced near the junction interfaces between the substrates 12 and 32 and the coating layers 14, 16, 34 and 36, so the optical properties of the substrates 12 and 13 is affected less. It is added that the stressless way does not mean that there is no stress at all induced near the junction interface, but mainly means that no stress enough to damage the crystalline texture of the substrates 12 and 32 is loaded onto the coating layers 14, 16, 34 and 36 and the substrates 12 and 32 during the forming of the coating layers 14, 16, 34 and 36. The above-mentioned roller coating and the following hardening process are suitable examples. Therefore, even though if there may exists residual stress induced by the UV hardening process at the junction interface, it is still regarded as the stressless way of the invention.

It is added that, for simple illustration, only the deformed area 524 in the substrate 52 is shown; in practice, the lamination process also induces a deformed area in the light-penetrable layer 54 so that the penetrability of the light-penetrable layer 54 is also reduced and the absorbed energy increases. It is not described repeatedly herein. In addition, for a common lamination process, the light-penetrable layer 54 needs to be formed in advance, so the thickness of the light-penetrable layer 54 is difficult to be thinned to several micro meters. Therefore, some of the current optical films involve other optical film structures into the light-penetrable layer 54 in the forming of the light-penetrable layer 54, so as to keep the whole thickness of the optical film from being excessively thick. For example, the light-penetrable layer 54 thereon also forms a saw-toothed surface as a prism layer in the lamination process. On the contrary, in the above embodiment according to the invention, the coating layers 14, 16, 34 and 36 of the optical composite substrates 1 and 3 can be formed on the substrates 12 and 32 by use of the roller coating, so the thicknesses of the coating layers 14, 16, 34 and 36 can be easily controlled to be several micro meters so that the whole thicknesses of the optical composite substrates 1 and 3 are almost the same as the thickness of the substrate 52 of the optical film 5 made by the lamination process. However, the optical composite substrates 1 and 3 have higher stiffness than the substrate 52.

As discussed above, the optical composite substrate of the invention forms two coating layers with same stiffness on the two sides of the substrate, so that the substantially symmetrical stress is induced on the substrate when the substrate tends to deform, which efficiently reduces the degree of the deformation of the whole optical composite substrate. Therefore, the optical composite substrate of the invention can efficiently reduce the deformation thereof without consideration to the orientation of the substrate when the temperature increases or the temperature distribution is non-uniform; it solves the warping problem of the optical film in the prior art. Further, if the stiffness of the coating layer is higher than the stiffness of the substrate, and the coating layers are structurally symmetrical to be formed on the substrate, the warping of the substrate can be almost reduced in principle so that the planarity of the optical composite substrate can be maintained. Furthermore, choosing a proper material for the coating layer is conducive to controlling the thickness of the coating layer, so that the whole optical composite substrate is only a little thicker than the substrate thereof. Therefore, the conventional substrate can be replaced with the optical composite substrate without modification of manufacturing parameters. In addition, the optical composite substrate of the invention can be manufactured by use of layer-coating equipment on hand so as to reduce the manufacturing load and modification cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical composite substrate, comprising:
a substrate, having a first surface and a second surface opposite to the first surface;
a first coating layer, formed on the first surface; and
a second coating layer, formed on the second surface, wherein a stiffness of the second coating layer is equal to a stiffness of the first coating layer.

2. The optical composite substrate of claim 1, wherein the stiffness the first coating layer is higher than a stiffness of the substrate.

3. The optical composite substrate of claim 1, wherein the first coating layer and the second coating layer are formed on the substrate to be structurally symmetrical.

4. The optical composite substrate of claim 3, wherein the substrate is mainly made of Polyethylene Terephthalate, and the first coating layer and the second coating layer are mainly made of UV hardened resin or epoxy resin.

5. The optical composite substrate of claim 1, wherein the substrate is mainly made of Polyethylene Terephthalate, and the first coating layer is mainly made of resin.

6. The optical composite substrate of claim 5, wherein the first coating layer is mainly made of UV hardened resin or epoxy resin.

7. The optical composite substrate of claim 1, wherein the substrate, the first coating layer, and the second coating layer are light-penetrable.

8. The optical composite substrate of claim 1, wherein the first coating layer comprises a plurality of organic or inorganic particles, reflective material, a plurality of metal particles, or glass fiber.

9. The optical composite substrate of claim 1, wherein a thickness of the first coating layer is 2.0%˜12.0% of a thickness of the substrate.

10. The optical composite substrate of claim 1, wherein a thickness of the first coating layer is 5 μm˜30 μm.

11. The optical composite substrate of claim 1, wherein the first coating layer and the second coating layer are formed directly on the substrate in a stressless way.

12. The optical composite substrate of claim 1, wherein the substrate is made of homogeneous or uniformly mixed material, and the first coating layer and the second coating layer are formed directly on the substrate.
